(19) United States
(12) Patent Application Publication
(10) Pub. No.: US 2016/0357240 A1
(43) Pub. Date: Dec. 8, 2016

(54) System and Method for Controlling Operation of Processor During Shipment

(71) Applicant: Under Armour, Inc., Baltimore, MD (US)

(72) Inventors: Mark A. Oleson, Baltimore, MD (US); F. Grant Kovach, Baltimore, MD (US); Nathan Dau, Baltimore, MD (US); Angela Nelligan, Baltimore, MD (US)

(21) Appl. No.: 14/730,624

(22) Filed: Jun. 4, 2015

(51) Int. Cl. G06F 1/32

(52) U.S. Cl. CPC G06F 1/3203

(57) ABSTRACT

A device has a body having a processing component and an orientation detecting component, and a cover disposed on the body. The processing component can operate in an inactive mode and can operate in an active mode, wherein the inactive mode expends less power than the active mode. The orientation detecting component can detect a first orientation and can generate an orientation signal based on the detected first orientation. The processing component can operate in one of the inactive mode or the active mode based on the orientation signal.

### BACKGROUND

The present invention generally deals with systems and methods for transporting battery powered electronics.

The use of wearable technology is rising, thanks to activity trackers, smart watches, global positioning system (GPS) watches, smart clothing and augmented reality devices. Electronic devices incorporated in wearable technology are shipped large distances over a long period of time before reaching an end user. If an electronic device is operating during the production and shipping of a wearable device, its battery power may be drained before ever reaching an end user.

Currently the battery used to power electronic devices in wearable technology may be disconnected using a pull tab. For devices using a pull tab, a thin film is inserted into the battery housing of an electronic device to separate the cathode or anode of the battery from the electronic device. In this manner, the circuit is open until an end user pulls the tab from the battery housing, closing the circuit.

Other electronic devices in wearable technology may have batteries that can be recharged. Once a piece of wearable technology is received by an end user, they may plug a power supply into the device to charge the battery. Alternatively, instead of charging the battery, a user may have to plug in a universal serial bus (“USB”) cord into the electronic device to activate it before it may be used.

A problem with recharging, user activation, or using pull tabs in wearable technology is that the battery of the electronic device may be embedded into the product and not be accessible by a user. For example, an electronic device may be used in a shoe to track travel distances. If the electronic device is embedded in the sole of the shoe, it cannot be recharged, activated, or reached to pull a tab from the battery housing.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a block diagram of a shipping route in accordance with aspects of the present invention;

FIG. 2 illustrates a block diagram of a device in accordance with aspects of the present invention;

FIG. 3 illustrates a method of operating a device in accordance with aspects of the present invention;

FIG. 4 illustrates an example shoe having a device in accordance with aspects of the present invention; and

FIG. 5 illustrates another example show having a device in accordance with aspects of the present invention.

### OVERVIEW

The present invention is drawn to a system and method for keeping a device to be used in wearable technology in an inactive mode or active mode based on the device's orientation.

An aspect of the present invention is drawn to a device that includes an orientation detector, a processing component and a battery. The orientation detector is used to determine the orientation of the device. If the orientation detector detects that the device is in a first orientation, the processing component of the device is put into inactive mode to conserve battery power. If the orientation detector detects that the device is in a second orientation, the processing component of the device is put into active mode. In active mode, the device may be put back into inactive mode if a parameter is not detected to prevent accidental activation.

Various embodiments described herein are drawn to a device that has a body having a processing component and an orientation detecting component and a cover disposed on the body. The processing component can operate in an inactive mode and can operate in an active mode, wherein the inactive mode expends less power than the active mode. The orientation detecting component can detect a first orientation and can generate an orientation signal based on the detected first orientation. The processing component can operate in one of the inactive mode or the active mode based on the orientation signal.

### EXAMPLE EMBODIMENTS

Conventionally, using electronic devices in wearable technology requires an end user to plug a power supply into the electronic device to charge the battery, or use a USB cord to activate the electronic device before it may be used. Alternatively, an end user may have to remove a pull tab that is used to separate the battery from the rest of the device.

The problem with recharging, user activation, or using pull tabs in wearable technology is that the electronic devices may not be accessible. If an electronic device is embedded into a wearable technology product, it may be difficult if not impossible to access.

The system and method in accordance with an aspect of the present invention uses an orientation sensor to detect the orientation of the electronic device used in a wearable technology product. In one orientation, the processing component of the electronic device can operate in an inactive mode, conserving the battery power of the electronic device. In another orientation, the processing component may operate in an active mode and be utilized by an end user.

Using an orientation sensor to determine the operating mode of a processing component allows less battery power to be consumed when the device is not in use. For example, a device may be placed in a shoe to track steps taken, distances travelled, time used, or other activity metrics (such as average speed, instantaneous/current speed, cadence, etc.). When the device is placed in the shoe, it may be placed such that it has an axis that is parallel or substantially parallel to an axis of the shoe. For example, a reference axis of the device (also referred to hereinafter as the device's Y-axis), may be parallel or substantially parallel to the same reference axis of the shoe (also referred to hereinafter as the shoe's Y-axis). When shoes are stored in their boxes to be stored or transported, they are placed on their sides, such that the Y-axis of the shoe is parallel to the ground. The orientation sensor in the device will detect that the shoes are on their sides and the processing component can begin operating in inactive mode, since shoes need their Y-axis to be perpendicular to the ground to be used.

The processing component may still accidentally begin operating in active mode during the shipping or storing process if the shoes happen to be bumped or moved such that in their new orientation, their Y-axes are perpendicular to the ground. In this case, the parameter detector provides an extra degree of protection.

The parameter detector used to detect parameters, e.g., track steps taken, distance travelled, or time used, transmits the detected parameter as a parameter signal to the processing component of the device. If the processing component processes the parameter signal and finds that there is no parameter detected by the parameter detecting component within a predetermined threshold, it will begin operating in inactive mode to conserve power. The processing component may continue operating in either inactive mode or active mode until a new orientation is detected by the orientation detector.

Aspects of the present invention are drawn to a system and method for operating a processing component of a device in an inactive mode or an active mode with the use of an orientation detecting component, a parameter detecting component and a processing component.

In accordance with an aspect of the present invention, an orientation detecting component is used to detect if a device is in a first orientation or a second orientation. If the orientation detector determines that the device is in a first orientation, it will generate and transmit an active orientation signal based on the detected orientation to the processing component. The processing component will then begin operating in active mode based on the active orientation signal. In other words, the active orientation signal will provide an indication (e.g., a message or other electrical instruction) to the processing component that causes the processing component to operate in the active mode.

In active mode, the processing component expends more energy per unit of time than when it is operating in inactive mode. In active mode the processing component begins processing data transmitted by the parameter detecting component. After processing the data from the parameter detecting component, the processing component may store the processed data to be accessed at a later time, or transmit it to a secondary device. For example, data from the parameter detecting component may be collected over the course of an exercise activity, and such data may be stored (e.g., at a memory component on the device and/or an external memory component) for transmission to the secondary device (e.g., a server). Likewise, or simultaneously, the data from the parameter detecting component may be streamed to the secondary device in real-time or substantially in real-time.

While processing data, if the processing component determines that the parameter detecting component has not detected a parameter input within a predetermined amount of time, it will begin operating in inactive mode. While operating in inactive mode, the processing component does not process, store, or transmit any data which results in less power to be expended per unit of time than while operating in active mode.

Alternatively, if the orientation detecting component detector determines that the device is in a second orientation, it will generate and transmit an inactive orientation signal based on the detected orientation to the processing component. The processing component will then begin operating in inactive mode based on the inactive orientation signal.

The ability of the processing component to operate in an inactive mode conserves battery life during the production and shipping phases of the device. In this manner, the battery will be able to provide power for the device, even with a long duration of time in between the devices production and interaction with an end user.

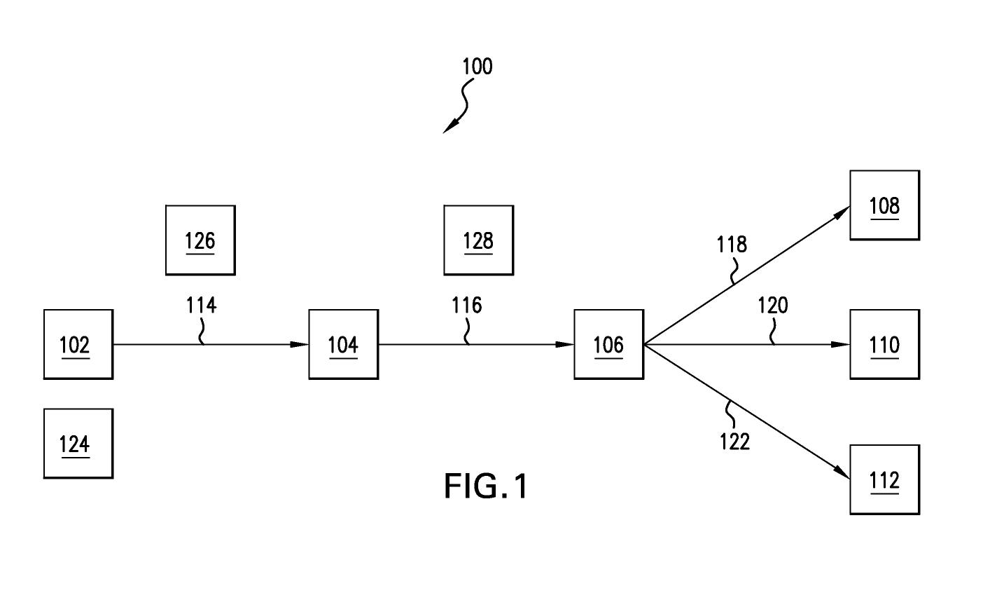

Example systems in accordance with the first inventive aspect of the present invention will now be described with reference to FIGS. 1-5.

FIG. 1 illustrates a block diagram 100 of a device's shipping route in accordance with aspects of the present invention.

As illustrated in the figure, block diagram 100 includes a manufacturing location 102, an assembly location 104, a distribution location 106, a first commercial location 108, a second commercial location 110, a third commercial location 112, a manufactured transportation method 114, an assembled transportation method 116, a commercially-ready transportation method 118, a commercially-ready transportation method 120, a commercially-ready transportation method 122, a plurality of component 124, a device 126 and a wearable device 128.

Wearable device 128 may be any wearable device that has a device 126 incorporated therein. Non-limiting examples of wearable device 128 include articles of clothing, jewelry, footwear, head wear and eyewear.

For purposes of discussion, consider the non-limiting example where plurality of components 124 includes components such as detectors, processors and a power source are assembled into device 126, wherein the chip is subsequently associated with wearable device 128, such as a shoe, and wherein the wearable device is finally purchased and used by an end user. In FIG. 1, components 124 are represented by a single box, though it should be appreciated that this single box may comprise the multiple components. For purposes of simplicity, components 124 are shown in FIG. 1 as being separate from device 126. It should be appreciated that components 124 may be integrated into device 126 before device 126 traverses the shipping route (or any time during traversal of the route). Likewise, components 124 may be integrated into device 126 after the device 126 traverses the shipping route (or any time during traversal of the route). In other words, although components 124 are shown separately from device 126, it should be appreciated that this is merely an example and that component 124 may also be integrated in device 126.

In this example, assembly of device 126 from plurality of components 124 takes place at manufacturing location 102. Once device 126 is assembled, if the power source (not shown in FIG. 1) of device 126 is electrically connected so as to provide power to device 126, device 126 may unacceptably start losing power. For example, many assembled chips may be stacked together into a package. These packages of stacked chips may then be transported via manufactured transportation method 114 to assembly location 104. Manufactured transportation method 114 may be any known transportation method, such as by boat, train, plane or automobile. For purposes of discussion, let manufactured transportation method 114 be transportation by boat. Transportation by boat is a very slow method of transportation, and may take weeks or even months to travel between two locations. Additionally, if a large quantity of chips (such as device 126) is ordered, the devices made first may be stored for a long duration until all of the devices are produced and ready to be transported.

Since manufactured transportation method 114 may take a long time, resulting in a long duration of transit for device 126, much time will have lapsed from when device 126 is assembled to when it reaches assembly location 104 via manufactured transportation method 114. If measures are not taken, much power could be lost from the power source of device 126. An aspect of the invention addresses this issue, as will be further discussed later.

In this example, assembly of wearable device 128, which includes incorporation of device 126, takes place at assembly location 104. In some cases, a manufacturer may order a large quantity of chips (such as device 126) to keep in stock. In this case, there is a chance that device 126 may be stored for days, weeks, or months before being integrated into a product.

In any event once the wearable devices are manufactured, many manufactured wearable devices are stacked together into a package. Many packages of stacked wearable devices are then transported via assembled transportation method 116 to distribution location 106. Assembled transportation method 116 may be any known transportation method, such as by boat, train, plane or automobile. For purposes of discussion, let assembled transportation method 116 be transportation by plane. Transportation by plane is a fast method of transportation, but may be very jarring and turbulent, resulting in the orientation of wearable device 128 continually changing during the process.

From when device 126 is received at assembly location 104 to when wearable device 128 reaches distribution location 106, much more time will have lapsed, wherein if measures are not taken, much more power could be lost from the power source within device 126 of wearable device 128. Again, an aspect of the invention addresses this issue, as will be further discussed later.

In this example, transportation of manufactured wearable device 128 has two stages, but many more may be included. In this example, manufactured wearable device 128 is first transported via assembled transportation method 116 to distribution location 106. Then manufactured wearable device 128 may be transported to one of many stores to be sold to an end user. In particular, packages of stacked wearable devices may be transported from distribution location 106 to one of: first commercial location 108 via transportation method 118; second commercial location 110 via transportation method 120; and third commercial location 112 via transportation method 122. Commercial locations 108, 110 and 112 may represent store locations or other point of sale locations for wearable device 128. Commercially-ready transportation methods 118, 120 and 122 may be any known transportation method, such as by boat, train, plane or automobile. For purposes of discussion, let commercially-ready transportation methods 118, 120 and 122 each be transportation by truck. Transportation by truck is a slow method of transportation, and may take several days to travel between two locations. Additionally, transportation by truck is also very bumpy and jarring resulting in the orientation of wearable device 128 continually changing during the transportation process.

From the time wearable device 128 reaches distribution location 106 to when wearable device 128 reaches one of commercial locations 108, 110 and 112, much more time will have lapsed, wherein if measures are not taken, much more power could be lost from the power source within device 126 of wearable device 128. Again, an aspect of the invention addresses this issue, as will be further discussed later.

Finally, consider the situation where wearable device 128 is transported to commercial location 108. Wearable device 128 will eventually be unpacked and stored at location 108 for sale to an end user. From the time wearable device 128 reaches commercial location 108 to when the end user obtains and uses wearable device 128, much more time will have lapsed, wherein if measures are not taken, much more power could be lost from the power source within device 126 of wearable device 128. Again, an aspect of the invention addresses this issue, as will be further discussed later.

The life cycle of wearable device 128 begins long before it reaches an end user. Device 126 within wearable device 128 may spend weeks or months at any of manufacturing location 102, assembly location 104, distribution location 106, first commercial location 108, second commercial location 110 and third commercial location 112 and days or weeks being transported via any of transportation methods 114, 116, 118, 120 and 122. If device 126 is continually operating in active mode it may have consumed a large portion of its power before reaching a user.

A device in accordance with aspects of the present invention may operate in inactive mode, which consumes less power than its active mode. When such a device spends a large percentage of its time in inactive mode, its power may be conserved even if weeks or months pass before reaching an end user. Therefore a device and method in accordance with aspects of the present invention improves functioning of wearable devices because power is saved. Furthermore, a device and method in accordance with aspects of the present invention implements processing component decisions based on detected parameters to solve the problem of power wasting that is common in the industry of wearable devices.

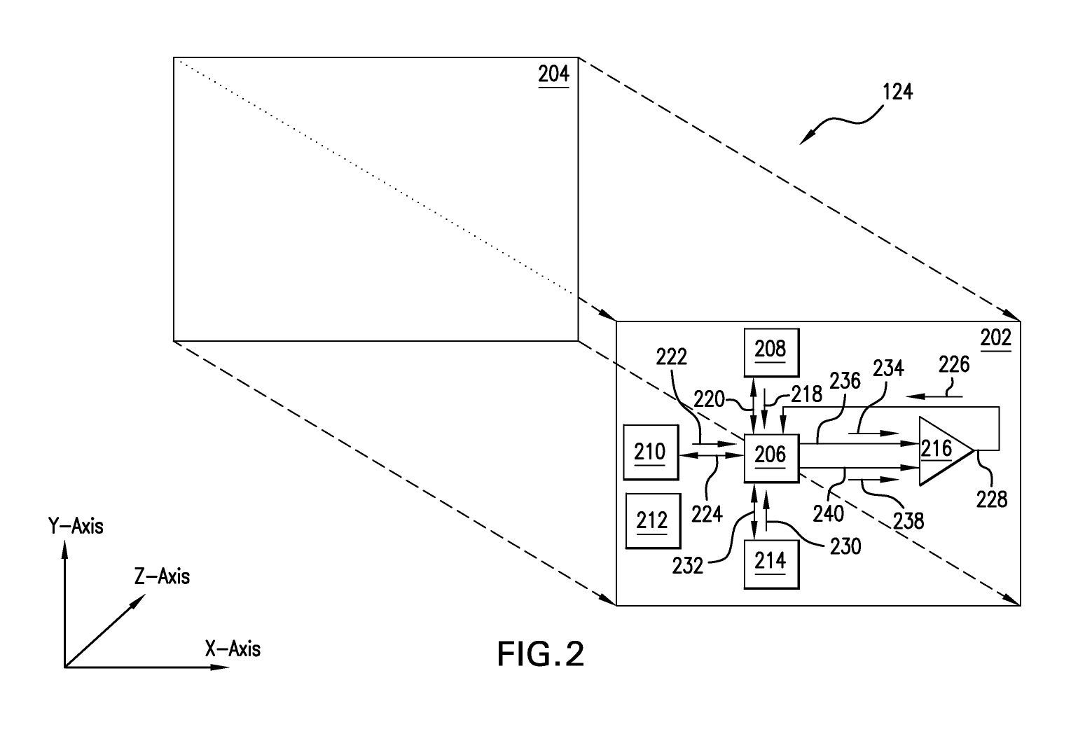

FIG. 2 illustrates a block diagram of a device 124 in accordance with aspects of the present invention.

FIG. 2 additionally includes a reference X-axis, a reference Y-axis and a reference Z-axis.

As illustrated in the figure, device 124 includes a body 202 and a cover 204. Body 202 further includes a processing component 206, an orientation detecting component 208, a parameter detecting component 210, a battery 212, a storage component 214, and a comparator 216.

Body 202 houses processing component 206, orientation detecting component 208 and parameter detecting component 210, battery 212, storage component 214, and comparator 216.

Cover 204 attaches to body 202 to enclose processing component 206, orientation detecting component 208, parameter detecting component 210, battery 212, storage component 214, and comparator 216. In some embodiments, cover 204 is detachably fastened to body 202, so cover 204 can be removed from body 202 to expose processing component 206, orientation detecting component 208, parameter detecting component 210, battery 212, storage component 214, and comparator 216.

In this example, processing component 206, orientation detecting component 208, parameter detecting component 210, battery 212, storage component 214, and comparator 216 are illustrated as individual devices. However, in some embodiments, at least two of processing component 206, orientation detecting component 208, parameter detecting component 210, battery 212, storage component 214, and comparator 216 may be combined as a unitary device. Further, in some embodiments, at least one of processing component 206, orientation detecting component 208, parameter detecting component 210, battery 212, storage component 214, and comparator 216 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media

Processing component 206 is arranged to receive an orientation signal 218 from orientation detecting component 208, via a line 220. Processing component 206 is additionally arranged to receive a parameter signal 222 from parameter detecting component 210, via a line 224. Processing component 206 is additionally arranged to receive a comparison signal 226 from comparator 216, via a line 228. Processing component 206 is additionally arranged to receive a priori data 230 from storage component 214, via a line 232. Processing component 206 is additionally arranged to output a detected signal 234 to comparator 216, via a line 236. Processing component 206 is additionally arranged to output an a priori signal 238 to comparator 216, via line 240.

Processing component 206 is able to operate in an inactive mode and to operate in an active mode based on orientation signal 218 from orientation detecting component 208. Processing component 206 expends less power when operating in the inactive mode than when operating in the active mode. Processing component 206 is may operate in the inactive mode or active mode additionally based on parameter signal 222 from detecting component 210. Processing component is able to control each of orientation detecting component 208, parameter detecting component 210, battery 212, storage component 214, and comparator 216.

Orientation detecting component 208 is operable to detect orientation of device 126 and output orientation signal 218 based on the detected orientation. When the detected orientation is associated with an inactive mode, orientation signal 218 will be an inactive orientation signal. When the detected orientation is associated with an active mode, orientation signal 218 will be an active orientation signal. In some embodiments, orientation detecting component 208 is operable to detect a change in orientation of device 126 and output orientation signal 218 based on the detected change in orientation. When the detected change in orientation is associated with an inactive mode, orientation signal 218 will be an inactive orientation signal. When the detected change in orientation is associated with an active mode, orientation signal 218 will be an active orientation signal.

Orientation detecting component 208 may be any device or system that is able to detect an orientation of device 124, or if the case may be, detect a change in orientation of device 126. In an example embodiment, orientation detecting component 208 is an accelerometer. In other non-limiting embodiments, orientation detecting component 208 may be a gyroscope, inertial sensor, or gravitometer.

Parameter detecting component 210 is operable to detect a parameter and generate parameter signal 222 based on the detected parameter. Non-limiting examples of parameters that may be detected include, sound, a change in sound, proximity, change in proximity, location, a change in location, position, velocity, acceleration, jerk, a change in jerk, temperature, a change in temperature, impedance, a change in impedance, resistance, a change in resistance, capacitance, a change in capacitance, inductance, a change in inductance, pressure, a change in pressure, magnetic field, a change in magnetic field, electric field, a change in electric field, an electromagnetic signal, a change in an electromagnetic signal, time, a change in time, a radio advertisement and combinations thereof.

Battery 212 provides power to device 126 provides power to processing component 206, orientation detecting component 208, parameter detecting component 210, storage component 214, and comparator 216 via any known system or method, a non-limiting example of which includes a supply bus (not shown).

Storage component 214 is operable to store a priori data therein. A priori data may include threshold data, orientation data and parameter data. The threshold data may include parameter thresholds and orientation data may include data corresponding to predetermined orientations of device 126 that are associated with an inactive mode of device 126, and data corresponding to predetermined orientations of device 126 that are associated with an active mode of device 126. Non-limiting examples of a priori data include: orientation data associated with an orientation of device 126 as it will packaged for transport along manufactured transportation method 114; orientation data associated with an orientation of wearable device 128 as it will packaged for transport along transportation methods 116, 118, 120 and 122; GPS data associated with a geodetic position of device 126 along transport the routes of transportation methods 114, 116, 118, 120 and 122 or the geodetic position of device 126 at locations 104, 106, 108, 110 and 112; data associated with a user using wearable device 128; and threshold data associated with a detectable parameter that may be detected which may include, sound, a change in sound, proximity, change in proximity, location, a change in location, position, velocity, acceleration, jerk, a change in jerk, temperature, a change in temperature, impedance, a change in impedance, resistance, a change in resistance, capacitance, a change in capacitance, inductance, a change in inductance, pressure, a change in pressure, magnetic field, a change in magnetic field, electric field, a change in electric field, an electromagnetic signal, a change in an electromagnetic signal, time, a change in time, a radio advertisement and combinations thereof.

Comparator 216 is operable to generate a comparison signal based on a difference between the detected signal from processing component 206, via line 236, and a priori signal 238 from processing component 206, via line 240.

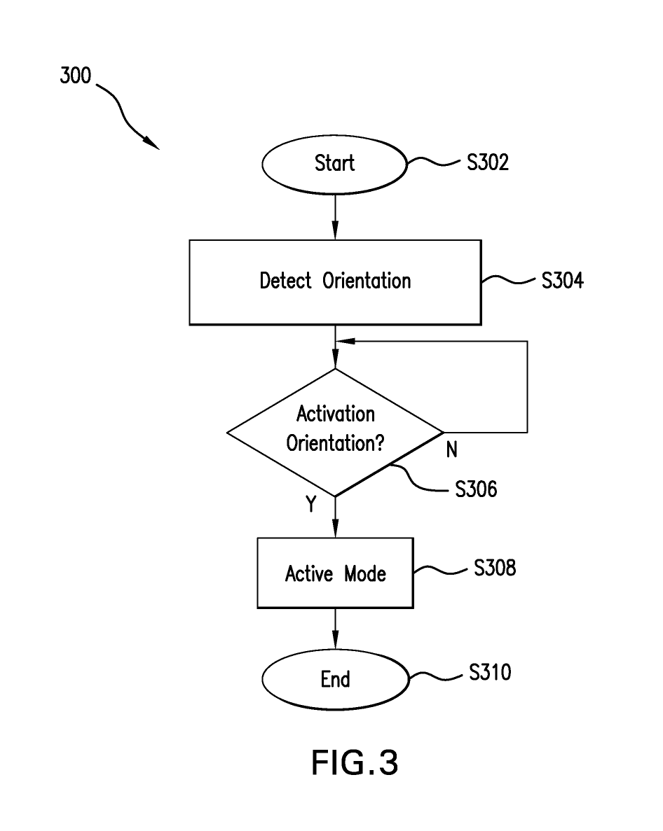

The operation of device 124 of FIG. 2 will now be further discussed with additional reference to FIG. 3.

FIG. 3 illustrates a method 300 of activating device in accordance with aspects of the present invention.

As shown in FIG. 3, method 300 starts (S302) and an orientation is detected (S304). For example, returning to FIG. 2, orientation detecting component 208 detects the orientation of device 126. For example, returning to FIG. 1, presume that device 126 corresponds to device 126 and wherein device 126 is stored in a specific predetermined manner having a corresponding specific predetermined orientation when transported via manufactured transportation method 114. This predetermined orientation would be detected by orientation detecting component 208. Similarly, device 126 as disposed within wearable device 128 is stored in a specific predetermined manner having a corresponding specific predetermined orientation when transported via assembled transportation method 116. This predetermined orientation would additionally be detected by orientation detecting component 208. Similarly, device 126 as disposed within wearable device 128 is stored in a specific predetermined manner having a corresponding specific predetermined orientation when transported via any of commercially-ready transportation methods 118, 120 and 122. This predetermined orientation would additionally be detected by orientation detecting component 208. Finally, device 126 as disposed within wearable device 128 is stored in a specific predetermined manner having a corresponding specific predetermined orientation when stored at any of commercial locations 108, 110 and 112. This predetermined orientation would additionally be detected by orientation detecting component 208.

In accordance with aspects of the present invention, orientation of device 126 is used to determine whether device 126 should be placed in an active or inactive mode of operation. However, there may be instances when device 126 erroneously placed in a particular mode of operation based on its orientation. For example, there may be instances is disposed in an orientation that is associated an active mode of operation, but should not be placed in an active mode of operation. Similarly, there may be instance when device 126 is disposed in an orientation that is associated an inactive mode of operation, but should not be placed in an inactive mode of operation.

To reduce the likelihood that device 126 is erroneously placed in a particular mode of operation based on its orientation, in some embodiments additional parameters may be detected, wherein the additional detected parameters are used in addition to the detected orientation to more accurately determine whether device 126 should be placed in an active or inactive mode of operation. Returning to FIG. 2, parameter detecting component 210 may detect the parameter, or parameters, and provide parameter signal 222 to processing component 206 via line 224.

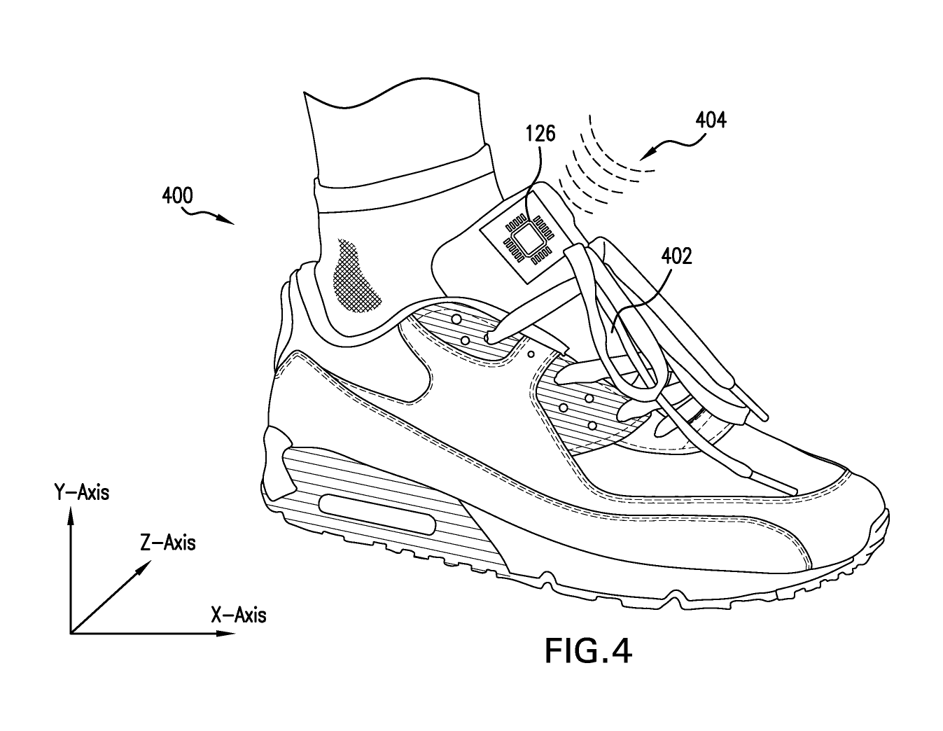

For example, in some embodiments, parameter detecting component 210 is a GPS device that is able to detect a geodetic position of device 126. This will be described with additional reference to FIG. 4.

FIG. 4 illustrates an example shoe 400 having device 126 in accordance with aspects of the present invention.

FIG. 4 additionally shows the reference X-axis, a reference Y-axis and a reference Z-axis of FIG. 2. When device 126 is placed in shoe 400, device 126 may be placed such that device 126 has an axis that is parallel or substantially parallel to an axis of the shoe. For example, a reference axis of device 126 (also referred to hereinafter as the device's Y-axis), may be parallel or substantially parallel to the same reference axis of shoe 400 (also referred to hereinafter as the Y-axis of shoe 400).

As shown in the figure, shoe 400 includes a tongue 402 and device 126 incorporated therein. In this example, device 126 is operable to detect a GPS signal 404.

For purposes of discussion, let the geodetic position of locations 102, 104, 106, 108, 110 and 112, and let the geodetic positions along transportation methods 114, 116, 118, 120 and 122, be associated with locations where device 126 should be placed in an inactive mode of operation. In this manner, even if orientation detecting component 208 where to detect an orientation associated with an active mode of operation, a geodetic position as detected by this example embodiment of parameter detecting component 210 that is associated with an inactive mode of operation may prevent device 126 from being erroneously placed in an active mode of operation.

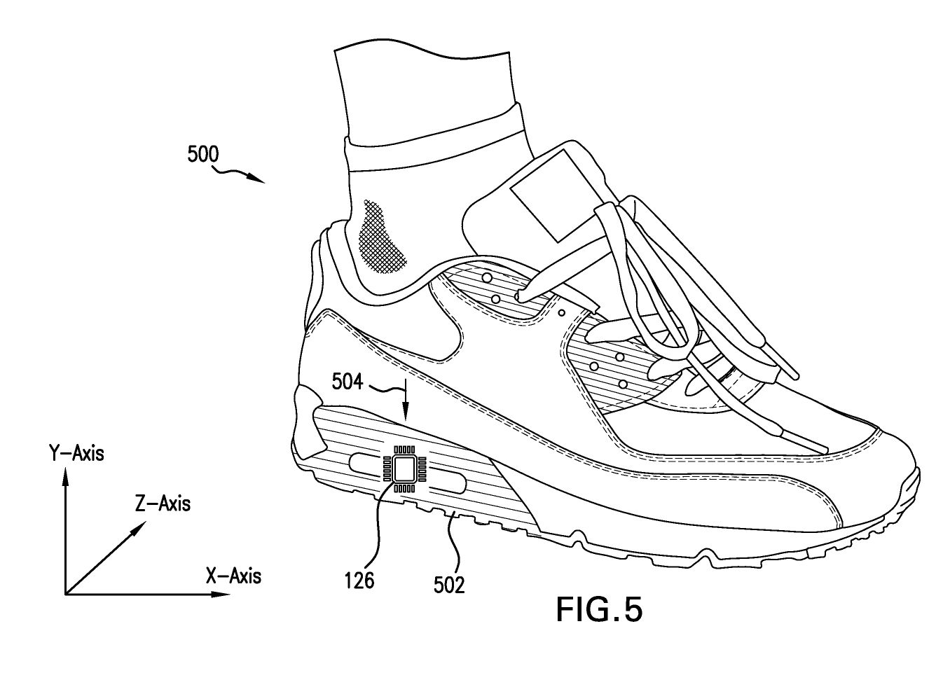

In other example embodiments, parameter detecting component 210 is a pressure sensing device that is able to detect pressure of device 126. This will be described with reference to FIG. 5.

FIG. 5 illustrates another example shoe 500 having device 124 in accordance with aspects of the present invention.

As shown in the figure, shoe 500 includes a sole 502 and device 126 incorporated therein. In this example, device 126 is operable to detect a pressure signal 504.

In this example, parameter detecting component 210 detects pressure associated with a person walking in shoe 500. In this manner, even if orientation detecting component 208 where to detect an orientation associated with an inactive mode of operation, a pressure as detected by this example embodiment of parameter detecting component 210 that is associated with an active mode of operation may prevent device 126 from being erroneously placed in an inactive mode of operation.

Returning to FIG. 3, once the orientation has (or orientation and other parameters have) been detected, it is determined whether the device is in an activation orientation (S306). For example, returning to FIG. 2, storage component 214 provides a priori data 230 associated with activation orientations to processing component 206 via line 232. Further, orientation detecting component 208 provides orientation signal 218 to processing component 206 via line 220. Processing component 206 provides detected signal 234 to comparator 216 via line 236 and provides a priori signal 238, associated with a priori data 230, to comparator 216 via line 240.

Detected signal 234 may be based on orientation signal 218, and additionally based on parameter signal 222 in cases where parameter signal 222 is provided. In some embodiments, detected signal 238 may be orientation signal 218. In some cases where parameter signal 222 is provided, detected signal 238 may be a combination of orientation signal 218 and parameter signal 222. In some embodiments, detected signal 238 may be based on orientation signal 218. In some cases where parameter signal 222 is provided, detected signal 238 may be based on a combination of orientation signal 218 and parameter signal 222.

A priori signal 238 may be based on a priori data 230 in any known manner. In some embodiments, a priori signal 238 may be a priori data 230. In some embodiments, a priori signal 238 is based on a priori data 230.

Comparator 216 compares a priori signal 238 with detected signal 234 and outputs comparison signal 226 to processing component 206 via line 228. Comparator generates comparison signal 226 in a manner such that processing component 206 would affirmatively recognize when device 200 should be placed in an active mode and would affirmatively recognize when device 200 should remain in an inactive mode.

In some embodiments comparison signal 226 would affirmatively instruct processing component 206 to be in a particular mode when a priori signal 238 is within a predetermined threshold of similarity of detected signal 234. For example, storage component may store data associated with an orientation of device 200 as it would be installed in device 128, as device 128 would be transported along assembled transportation method 116. Further, let device 200 be installed in device 128 and let device 128 be en route in assembled transportation method 116. For purposes of discussion, let the orientation of device 200 change slightly while on route in assembled transportation method 116, wherein the change in orientation of device 200 be within the predetermined threshold of similarity. In such a case, orientation signal 218 would be an inactive orientation signal and would correspond to the orientation of device 200 as installed in device 128, as device 128 is transported along assembled transportation method 116. Further, detected signal 234, which corresponds to the orientation of device 200, would be sufficiently similar to a priori signal 238. As such, comparison signal would affirmatively instruct processing component 206 to remain in the inactive mode.

There may be situations where device 200 briefly disposed in an orientation associated with an active mode, when device 200 should not be in an active mode. For example returning to FIG. 1, while transitioning from assembled transportation method 116 to transportation method 120 at distribution location 106, suppose that device 200 is briefly disposed in an orientation associated with an active mode. It would be bad, if device 200 were to be place in an active mode in such situations. Specifically, if device 200 where to spend three weeks in transportation method 120 and then spend another two months at location 110 before being purchased by a user, device 200 may lose two months and three weeks' worth of energy.

To prevent such a situation where device 200 is briefly disposed in an orientation associated with an active mode, when device 200 should not be in an active mode, in some embodiments device 200 will detect orientation within a predetermined period of time. More specifically, in some embodiments, device 200 will only determine that device 200 should be placed in an active mode if it is determined that device 200 is in an orientation associated with an active mode for longer than a predetermined period of time.

For example, let orientation detecting component 208 detect the orientation of device 200 at a first time, t₁. Suppose for the purposes of discussion that the orientation of device 200 at time t₁ is an orientation sufficiently similar to an orientation associated with an active mode as stored in storage component 214 as a priori data. In this embodiment, before device 200 is place in an active mode, processing component 206 will wait a predetermined amount of time. For purposes of discussion, let the predetermined amount of time be 30 minutes.

Now, suppose that within 30 minutes of t₁, for purposes of discussion, let the orientation of device 200 be that associated with an inactive mode because wearable device 128 has been successfully loaded in the transport for transportation method 120. In such a case, in this embodiment, orientation detecting component 208 would detect the orientation of device 200 at a second time, t₂, after the predetermined amount time has lapsed. In this case, the orientation of device 200 at time t₂ is not an orientation sufficiently similar to an orientation associated with an active mode as stored in storage component 214 as a priori data. In particular, the orientation of device 200 at time t₂ is not the same as the orientation of time t₁, because wearable device 128 has been successfully loaded in the transport for transportation method 120.

To save power, in some embodiments, when an orientation associated with an active mode is detected, orientation detecting component may only detect orientation again after the predetermined threshold, i.e., when the difference between t₁ and t₂ is greater than the predetermined threshold.

Returning to FIG. 3, in situations where it is determined that there is an activation orientation (Y at S306), then device 126 is placed in an activation mode (S308). For example, as shown in FIG. 2, in situations where the orientation as detected by orientation detection component 208 corresponds to a predetermined orientation, i.e., detected signal 234 from processing component 206 corresponds to a priori signal 238 from processing component 206, comparison signal 226 will instruct processing component 206 to place device 126 in the appropriate mode of operation. For example, if the detected orientation corresponds to an activation mode of operation, the predetermined orientation corresponds to an activation mode of operation and the detected orientation corresponds to the predetermined orientation, then device 126 will be placed in an activation mode of operation.

Alternatively, if the detected orientation corresponds to an inactive mode of operation (N at S306), then device 126 will stay in an inactive mode of operation.

Once device 126 has been placed in the active mode, method 300 stops (S310). For example, when a person purchase a wearable device, having device 126 therein, and uses the wearable device, device 126 will be in the active mode.

In some embodiments, a predetermined threshold is set to enable comparator 216 to generate comparison signal 226 to allow processing component 206 to operate in active mode, such as when an end user is using wearable device 128. This allows process component 206 to continue operating in inactive mode when there a quick and sudden changes in orientation of device 126 or wearable device 128 that may be associated with bumps and jarring that occurs during the transportation process.

In the non-limiting example embodiments discussed above, a device in accordance with aspects of the present invention is able to operate in an active mode and an inactive mode, wherein while in the inactive mode, the device expends less power than the active mode. It should be noted that in other non-limiting example embodiments, a device in accordance with aspects of the present invention may be able to operate in a plurality of modes, wherein while in each mode, the device expends a different amount of energy, respectively. A device in accordance with aspects of the present invention that operates in a plurality of modes, will operate in a particular mode based on a detected orientation or change in orientation in a manner as discussed above. In these such embodiments, each mode of operation will have an associated orientation.

For example, in some embodiments, a device in accordance with aspects of the present invention is able to operate in an active mode, a storage mode and an inactive mode, wherein while in the storage mode, the device expends less power than the active mode, but more power than the inactive mode. A predetermined orientation of the device is associated with the storage mode. When the orientation of the device as associated with the storage mode is detected, the orientation detecting component will generate the orientation signal as a storage orientation signal. The device will then operate in the storage mode.

A problem with the conventional system and method for using electronic devices in wearable technology is that they require recharging, user activation, or pull tabs to conserve battery power before reaching an end user. Recharging, user activation, and pull tabs may not be viable in situations when the electronic device being used is embedded within the product.

With the conventional system and method, when the device is embedded in the product, it may operate continually during the production and shipping process. Due to the long durations of time in each phase of the production process, the continual operating of a device may drain its power supply before ever reaching an end user

Aspects in accordance with the present invention include a system and method for conserving power in electronic devices used in wearable technology using an orientation detecting component. The orientation detecting component is used to determine if the device is used to place the device in an active or inactive mode based on a predetermined orientation(s).

The ability of a device in accordance with aspects of the present invention to operate in an inactive mode while not in use enables the device to conserve energy. This conservation of energy allows the device to be operated by an end user without the need for using pull tabs, user activation, or charging. Additionally, since the device requires no external input to operate, it may be embedded into a product in an inaccessible location while still operating as intended.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device comprising:
a body having a processing component and an orientation detecting component; and
a cover disposed on said body,
wherein said orientation detecting component is operable to detect a first orientation of the device and to generate an orientation signal based on the detected first orientation of the device, and
wherein said processing component is operable to operate in one of an inactive mode or an active mode based on the orientation signal, the inactive mode expending less power than the active mode.

2. The device of claim 1,
wherein said orientation detecting component is operable to detect a second orientation of the device,
wherein the second orientation of the device is different from the first orientation of the device,
wherein said orientation detecting component is operable to generate the orientation signal as an active orientation signal when said orientation detecting component detects the first orientation of the device, and
wherein said orientation detecting component is operable to generate the orientation signal as an inactive orientation signal when said orientation detecting component detects the second orientation of the device.

3. The device of claim 2,
wherein said orientation detecting component is operable to detect the first orientation at a first time,
wherein said orientation detecting component is operable to detect the first orientation at a second time, and
wherein said orientation detecting component is operable to generate the orientation signal when the difference between the first time and the second time is greater than a predetermined threshold.

4. The device of claim 1, further comprising:
a parameter detecting component operable to detect a parameter and to generate a parameter signal based on the detected parameter, and
wherein said processing component is operable to operate in one of the inactive mode or the active mode when the parameter signal is within a predetermined threshold.

5. The device of claim 4, wherein said parameter detecting component is operable to detect, as the parameter, one of the group selected from sound, a change in sound, proximity, change in proximity, location, a change in location, position, velocity, acceleration, jerk, a change in jerk, temperature, a change in temperature, impedance, a change in impedance, resistance, a change in resistance, capacitance, a change in capacitance, inductance, a change in inductance, pressure, a change in pressure, magnetic field, a change in magnetic field, electric field, a change in electric field, an electromagnetic signal, a change in an electromagnetic signal, time, a change in time, a radio advertisement and combinations thereof.

6. The device of claim 1:
wherein said processing component is additionally operable to operate in a storage mode, the storage mode expending less power than the active mode,
wherein said orientation detecting component is operable to generate the orientation signal as an active orientation signal when said orientation detecting component detects the first orientation of the device,
wherein said orientation detecting component is operable to detect a second orientation of the device, and
wherein said orientation detecting component is operable to generate the orientation signal as a storage orientation signal when said orientation detecting component detects the second orientation of the device.

7. A method comprising:
operating a processing component of a device in an inactive mode, the inactive mode expending a first amount of energy per unit of time;
detecting, via an orientation detecting component, a first orientation of the device;
generating, via the orientation detecting component, an orientation signal based on the detected first orientation of the device;
operating the processing component in one of an active mode or the inactive mode based on the orientation signal, the active mode expending a less power than the active mode.

8. The method of claim 7, further comprising:
detecting, via the orientation detecting component, a second orientation of the device,
wherein the second orientation of the device is different from the first orientation of the device,
wherein said generating an orientation signal based on the detected first orientation comprises generating the orientation signal as an active orientation signal when the orientation detecting component detects the first orientation of the device, and
wherein said generating an orientation signal based on the detected first orientation comprises generating the orientation signal additionally based on the detected second orientation of the device as an inactive orientation signal when the orientation detecting component detects the second orientation of the device.

9. The method of claim 8, further comprising:
wherein said detecting the first orientation comprises detecting the first orientation at a first time,
wherein said detecting the first orientation comprises detecting the first orientation at a second time, and
wherein said generating the orientation signal as an active orientation signal when the orientation detecting component detects the first orientation of the device comprises generating the active orientation signal when the difference between the first time and the second time is greater than a predetermined threshold.

10. The method of claim 7, further comprising:
detecting, via a parameter detecting component, a parameter;
generating, via the parameter detecting component, a parameter signal based on the detected parameter, and
wherein said operating the processing component in an active mode based on the orientation signal comprises operating the processing component in the active mode additionally when the parameter signal is within a predetermined threshold.

11. The method of claim 10, wherein said detecting, via a parameter detecting component, a parameter comprises detecting, as the parameter, one of the group selected from sound, a change in sound, proximity, change in proximity, location, a change in location, position, velocity, acceleration, jerk, a change in jerk, temperature, a change in temperature, impedance, a change in impedance, resistance, a change in resistance, capacitance, a change in capacitance, inductance, a change in inductance, pressure, a change in pressure, magnetic field, a change in magnetic field, electric field, a change in electric field, an electromagnetic signal, a change in an electromagnetic signal, time, a change in time, a radio advertisement and combinations thereof.

12. The method of claim 7, further comprising:
detecting, via the orientation detecting component, a second orientation of the device;
generating, via the orientation detecting component, a second orientation signal based on the detected second orientation; and
operating the processing component in a storage mode based on the second orientation signal,
wherein the storage mode expends less power than the active mode.

13. A non-transitory, tangible, computer-readable media having computer-readable instructions stored thereon, for use with a computer and being capable of instructing the computer to perform the method comprising:
operating a processing component of a device in an inactive mode, the inactive mode expending a first amount of energy per unit of time;
detecting, via an orientation detecting component, a first orientation of the device;
generating, via the orientation detecting component, an orientation signal based on the detected first orientation of the device;
operating the processing component in one of an active mode or the inactive mode based on the orientation signal, the active mode expending a less power than the active mode.

14. The non-transitory, tangible, computer-readable media of claim 13, wherein the computer-readable instructions are capable of instructing the computer to perform the method further comprising:
detecting, via the orientation detecting component, a second orientation of the device,
wherein the second orientation of the device is different from the first orientation of the device,
wherein said generating an orientation signal based on the detected first orientation comprises generating the orientation signal as an active orientation signal when the orientation detecting component detects the first orientation of the device, and
wherein said generating an orientation signal based on the detected first orientation comprises generating the orientation signal additionally based on the detected second orientation of the device as an inactive orientation signal when the orientation detecting component detects the second orientation of the device.

15. The non-transitory, tangible, computer-readable media of claim 14, wherein the computer-readable instructions are capable of instructing the computer to perform the method further comprising:
wherein said detecting the first orientation comprises detecting the first orientation at a first time,
wherein said detecting the first orientation comprises detecting the first orientation at a second time, and
wherein said generating the orientation signal as an active orientation signal when the orientation detecting component detects the first orientation of the device comprises generating the active orientation signal when the difference between the first time and the second time is greater than a predetermined threshold.

16. The non-transitory, tangible, computer-readable media of claim 13, wherein the computer-readable instructions are capable of instructing the computer to perform the method further comprising:
detecting, via a parameter detecting component, a parameter;
generating, via the parameter detecting component, a parameter signal based on the detected parameter, and
wherein said operating the processing component in an active mode based on the orientation signal comprises operating the processing component in the active mode additionally when the parameter signal is within a predetermined threshold.

17. The non-transitory, tangible, computer-readable media of claim 16, wherein the computer-readable instructions are capable of instructing the computer to perform the method such that said detecting, via a parameter detecting component, a parameter comprises detecting, as the parameter, one of the group selected from sound, a change in sound, proximity, change in proximity, location, a change in location, position, velocity, acceleration, jerk, a change in jerk, temperature, a change in temperature, impedance, a change in impedance, resistance, a change in resistance, capacitance, a change in capacitance, inductance, a change in inductance, pressure, a change in pressure, magnetic field, a change in magnetic field, electric field, a change in electric field, an electromagnetic signal, a change in an electromagnetic signal, time, a change in time, a radio advertisement and combinations thereof.

18. The non-transitory, tangible, computer-readable media of claim 13, wherein the computer-readable instructions are capable of instructing the computer to perform the method further comprising:
detecting, via the orientation detecting component, a second orientation of the device;
generating, via the orientation detecting component, a second orientation signal based on the detected second orientation; and
operating the processing component in a storage mode based on the second orientation signal,
wherein the storage mode expends less power than the active mode.
